(19) United States
(12) Patent Application Publication
(10) Pub. No.: US 2022/0293956 A1
(43) Pub. Date: Sep. 15, 2022

(54) ELECTRODE FOR SOLID-STATE BATTERY AND SOLID-STATE BATTERY INCLUDING SAME

(71) Applicant: HONDA MOTOR CO., LTD., Tokyo (JP)

(72) Inventors: Pu QIAN, Saitama (JP); Hiroto MAEYAMA, Saitama (JP); Hiroshi SAKAI, Saitama (JP); Atsushi OGAWA, Saitama (JP); Noriaki KAMAYA, Saitama (JP)

(21) Appl. No.: 17/678,038

(22) Filed: Feb. 23, 2022

(30) Foreign Application Priority Data
Mar. 15, 2021 (JP) 2021-041597

(51) Int. Cl. H01M 4/62

(52) U.S. Cl. CPC H01M 4/628; H01M 4/623

(57) ABSTRACT

To provide an electrode for a solid-state battery, capable of improving uniformity of electrode materials and suppressing decomposition of a solid electrolyte or an electrode active material by a binder or a solvent. An electrode for a solid-state battery including a solid electrolyte including sulfide and/or oxide, an electrode active material, a binder, and a conductive auxiliary agent, at least one of the solid electrolyte and the electrode active material having a surface being modified with a surface modifying substance, wherein the surface modifying substance is at least one selected from the group consisting of carboxylate, thiocarboxylate, carboxylic acid, thiocarboxylic acid, phosphate ester, thiophosphate ester, ketone, nitrile, alcohol, thiol, and ether.

This application is based on and claims the benefit of priority from Japanese Patent Application No. 2021-041597, filed on 15 Mar. 2021, the content of which is incorporated herein by reference.

### BACKGROUND OF THE INVENTION

### Field of the Invention

The present invention relates to an electrode for a solid-state battery and a solid-state battery including the same.

### Related Art

Demand for high-capacity and high-power batteries is rapidly expanding with the spread of large and small electric and electronic equipment such as automobiles, personal computers, and mobile phones. Demand for batteries with high energy density and output is high among various batteries, and further development of high-performance batteries is expected. Among them, solid state batteries are attracting attention because they are excellent in safety because of the incombustibility of a solid electrolyte and in having a higher energy density.

In the electrode of such solid batteries, while the polarity of the surface of the electrode active material and the solid electrolyte is strong, there is almost no polarity on the surface of the conductive auxiliary. As a result, slurry in which each is uniformly mixed is not easily obtained by kneading. Therefore, in order to obtain slurry in which the respective electrode materials are uniformly mixed, attempts have been made to suppress an oxidation reaction on the interface between the electrode active material and the solid electrolyte, and to suppress oxidation of the solid electrolyte by mixing a small amount of oxide into the solid electrolyte including sulfide.

Patent Document 1 proposes a technology in which a binder, surface modifying substances serving as a surface modifying agent, or a dispersion medium are added to a solid electrolyte composition in an electrode layer material including an inorganic solid electrolyte, a surface modifying substance, and an active material, thereby favorably dispersing the active material and the inorganic solid electrolyte by the interaction of the surface modifying substances to achieve uniform distribution and to improve output of entire solid secondary battery.
Patent Document 1: PCT International Publication No. WO2016/047946

### SUMMARY OF THE INVENTION

However, this time, the present applicant has found that an electrode active material or a solid electrolyte is decomposed by a binder or a solvent. Therefore, an electrode for a solid-state battery, capable of improving uniformity of electrode materials and suppressing decomposition of a solid electrolyte or an electrode active material by a binder or a solvent is desired.

The present invention has been made in view of the above, and has an object to provide an electrode for a solid-state battery capable of improving uniformity of electrode materials and suppressing decomposition of a solid electrolyte or an electrode active material by a binder or a solvent.

(1) The present invention provides an electrode for a solid-state battery, including a solid electrolyte including sulfide and/or oxide, an electrode active material, a binder, and a conductive auxiliary agent, at least one of the solid electrolyte and the electrode active material having a surface being modified with a surface modifying substance, wherein the surface modifying substance is at least one selected from the group consisting of carboxylate, thiocarboxylate, carboxylic acid, thiocarboxylic acid, phosphate ester, thiophosphate ester, ketone, nitrile, alcohol, thiol, and ether.

(2) In the electrode for a solid-state battery according to (1), the surface modifying substance may have a carbon chain having 1 to 11 carbon atoms.

(3) In the electrode for a solid-state battery according to (1) or (2), the surface modifying substance may have a carbon chain having 1 to 6 carbon atoms.

(4) In the electrode for a solid-state battery according to any one of (1) to (3), the surface modifying substance may have a carbon chain having 1 to 4 carbon atoms.

(5) In the electrode for a solid-state battery according to any one of (1) to (4), the surface modifying substance may be at least one selected from the group consisting of lithium butyrate, lithium isobutyrate, lithium acetate, butyl phosphate, and isobutyronitrile.

(6) In the electrode for a solid-state battery according to any one of (1) to (5), the binder may be a binder having relatively lower polarity than the solid electrolyte and the electrode active material before a surface thereof is modified with the surface modifying substance, or a binder having no polarity.

(7) in the electrode for a solid-state battery according to any one of (1) to (6), the binder may be at least one selected from the group consisting of polyethylene vinyl acetate (PEVA), polymethyl methacrylate (PMMA), styrene-butadiene rubber (SBR), hydrogenated nitrile-butadiene rubber (HNBR), nitrile-butadiene rubber (NBR) and polyisobutene (PIB).

(8) In the electrode for a solid-state battery according to any one of (1) to (7), the solid electrolyte may be a sulfide solid electrolyte having an argyrodite type crystal structure.

(9) In the electrode for a solid-state battery according to any one of (1) to (8), the electrode active material may be a positive electrode active material, and the electrode for a solid-state battery may be a positive electrode for a solid-state battery.

(10) Furthermore, the present invention provides a solid-state battery comprising the electrode for a solid-state battery according to any one of (1) to (9).

The present invention can provide an electrode for a solid-state battery, capable of improving uniformity of electrode materials and suppressing decomposition of a solid electrolyte or an electrode active material by a binder or a solvent, and a solid-state battery including the same.

### BRIEF DESCRIPTION OF THE DRAWINGS

FIG. 1 is a view showing a configuration of a solid-state battery 10 in accordance with one embodiment of the present invention;

FIG. 2 is a chart showing an IR spectrum of a solid electrolyte in accordance with an Example of the present invention;

FIG. 3 is a chart showing an IR spectrum of a solid electrolyte in accordance with an Example of the present invention; and

FIG. 4 is a chart showing an IR spectrum of a solid electrolyte in accordance with an Example of the present invention.

### DETAILED DESCRIPTION OF THE INVENTION

Hereinafter, an electrode for a solid-state battery of the present invention and a method for manufacturing the same will be described with reference to drawings, but the present invention is not limited thereto.

(Solid-State Battery)

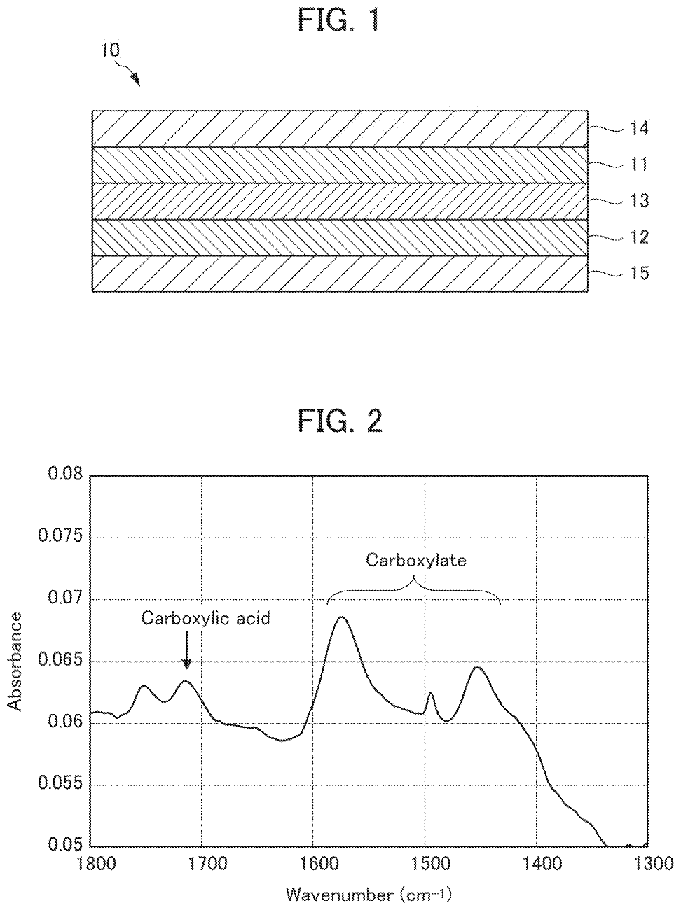

FIG. 1 is a view showing an outline of a solid-state battery 10 of the present invention. The solid-state battery 10 of the present invention is formed in a layer, includes a positive electrode current collector 14, a positive electrode layer 11, a negative electrode current collector 15, a negative electrode layer 12, and a solid electrolyte layer 13 interposed between these electrode layers, and further includes a positive electrode current collector 14 for collecting the positive electrode current and a negative electrode current collector 15 for collecting the negative electrode current. In the solid electrolyte layer 14, the positive electrode layer 11, and the negative electrode layer 12, a surface of at least one of the solid electrolyte and the electrode active material is modified with a surface modifying substance. Furthermore, a layer of the solid-state battery of the present invention includes, for example, the negative electrode current collector 15, the negative electrode layer 12, the solid electrolyte layer 13, the positive electrode layer 11, and the positive electrode current collector 14 sequentially from the bottom of FIG. 1.

(Electrode Layer)

An electrode layer to be used for the solid-state battery of the present invention is a layer containing at least an electrode active material, a solid electrolyte, a binder, and a surface modifying substance modifying a surface of at least one of the electrode active material and the solid state electrolyte. For each of the electrode active material, the solid electrolyte, the binder, and the surface modifying substance modifying a surface of at least one of the electrode active material and the solid state electrolyte, materials described in the following paragraph can be used. In the present invention, the electrode layer is collectively referred to as a positive electrode layer and a negative electrode layer. Furthermore, the electrode active material is collectively referred to as a positive electrode active material and a negative electrode active material.

[Electrode Material Mixture]

In the present invention, an electrode material mixture includes at least an electrode active material, a solid electrolyte, a binder, a surface modifying substance modifying at least one of the electrode active material and the solid electrolyte, and a solvent. The electrode material mixture that can be applied for the present invention may include any other components as long as they include the above-mentioned materials. The other components are not particularly limited, and any components that can be used for producing the solid-state battery may be used. The positive electrode material mixture constituting the positive electrode contains at least the electrode active material, the solid electrolyte, the binder, the surface modifying substance modifying a surface of at least one of the electrode active material and the solid electrolyte, and the solvent. As the other components, a conductive auxiliary agent and the like may be contained. Examples of the positive electrode active material can include materials mentioned later. Furthermore, the negative electrode material mixture has the same configuration as that of the positive electrode material mixture except that the configuration includes a negative electrode active material instead of the positive electrode active material. Examples of the negative electrode active material can include materials mentioned later.

(Positive Electrode Active Material)

The positive electrode active material can be the same as materials to be used for a positive electrode active material layer of a common solid-state battery, and is not particularly limited. For example, in the case of a lithium ion battery, lithium-containing layered active material, spinel type active material, olivine type active material, and the like, can be used. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}COᵣO₂ (p+q+r=1), lithium manganate (LiMn₂O₄), dissimilar element-substituted Li—Mn spinel represented by Li₁+xMn₂-x-yMyO₄ (x+y=2, M is at least one selected from Al, Mg, Co, Fe, Ni and Zn), and the like.

Preferably, the positive electrode active material has a surface coated with, for example, oxide such as LiNbO₃. This suppresses decomposition of the positive electrode active material by a binder or a solvent. In other words, the oxide coating layer such as LiNbO₃ functions as a reaction suppressing layer for suppressing a reaction between the positive electrode active material and the binder or solvent.

For example, coating with the above-mentioned reaction suppression layer is carried out as follows. Firstly, a precursor solution of the reaction inhibition layer is prepared. For example, LiOC₂H₅ is dissolved in ethanol solvent such that ethanol includes a predetermined amount of ethoxylithium (LiOC₂H₅) and pentaethoxyniobium (Nb(OC₂H₅)₅), and then, Nb(OC₂H₅)₅ is added and dissolved to prepare a precursor solution of LiNbO₃ reaction suppression layer.

Next, coating of the reaction suppression layer precursor solution to the positive electrode active material is carried out by using, for example, a rolling flow coater. A positive electrode active material coated with a precursor of a LiNbO₃ reaction suppressing layer is obtained by putting Li_{1.15}Ni_{0.33}Co_{0.33}Mn_{0.33}O₂ particles which are lithium transition metal composite oxides into a tumbling fluidized coating device, and spraying a precursor solution while rolling up positive electrode active material by dry air and circulating it in the rolling flow coater.

Next, the positive electrode active material coated with the precursor of the LiNbO₃ reaction suppressing layer is heat-treated in an atmosphere in an electric furnace to obtain the positive electrode active material coated with the LiNbO₃ reaction suppressing layer.

In the positive electrode active material of the present invention, it is also preferable that a surface is modified with a surface modifying substance to be described later regardless of the presence or absence of the coating of the reaction inhibiting layer. More preferably, the positive electrode active material coated with the reaction inhibiting layer is surface-modified with a surface modifying substance.

(Negative Electrode Active Material)

The negative electrode active material is not particularly limited as long as it can absorb and release a charge transfer medium. For lithium ion batteries, examples include lithium transition metal oxides such as lithium titanate (Li₄Ti₅O₁₂), transition metal oxides such as TiO₂, Nb₂O₃, and WO₃, metal sulfides, metal nitrides, and carbon materials such as graphite, soft carbon, and hard carbon, and metal lithium, metal indium, and lithium alloys, silicon oxide, silicon, and the like. Furthermore, the negative electrode active material may be powder or a thin film. A surface of the negative electrode active material is preferably coated with, for example, oxide such as LiNbO₃ in the same manner as the positive electrode active material. A preferable coating method of the oxide coating layer on the negative electrode active material is also preferably performed by the same method as for the positive electrode active material. In the negative electrode active material of the present invention, it is also preferable that a surface is modified with a surface modifying substance to be described later regardless of the presence or absence of the coating of the reaction inhibiting layer. More preferably, the negative electrode active material coated with the reaction inhibiting layer is surface-modified with a surface modifying substance.

(Solid Electrolyte)

The solid electrolyte material is not particularly limited as long as it has charge transfer medium conductivity, and examples thereof include a sulfide solid electrolyte material, an oxide solid electrolyte material, a nitride solid electrolyte material, a halide solid electrolyte material, and the like. Among them, it is preferable to use an oxide solid electrolyte material or a sulfide solid electrolyte material. More preferably, a sulfide solid electrolyte material can be used. This is because the sulfide solid electrolyte material has higher charge-transfer medium conductivity than the oxide solid electrolyte material. It is also preferable that the solid electrolyte material of the present invention is surface-modified with a surface modifying substance to be described later.

[Oxide Solid Electrolyte]

Examples of the oxide solid electrolyte material for a solid battery include NASICON type oxide, garnet type oxide, perovskite type oxide, and the like. Examples of the NASICON type oxide include oxide containing Li, Al, Ti, P, and O (for example, Li_{1.5}Al_{0.5}Ti_{1.5} (PO₄)₃). Examples of the garnet type oxide include oxide containing Li, La, Zr, O (for example, Li₂La₃Zr₂O₁₂). Examples of the perovskite type oxide include oxide containing Li, La, Ti, and O (for example, LiLaTiO₃).

[Sulfide Solid Electrolyte]

Sulfide solid electrolyte usually contains a metallic element (M) that becomes a conducting ion and sulfur (S). Examples of M include Li, Na, K, Mg, Ca, and the like. M is Li in this embodiment that requires Li ionic conductivity. In particular, the sulfide solid electrolyte of the present invention preferably contains Li and A (A is at least one selected from the group consisting of P, Si, Ge, Al, and B), and S. Furthermore, A is preferably P (phosphorus). Furthermore, a sulfide solid electrolyte 12 may contain halogen such as Cl, Br, and I from the viewpoint of improvement of the ionic conductivity. Furthermore, the sulfide solid electrolyte may contain O (oxygen). In addition, the sulfide solid electrolyte preferably has an argyrodite type crystal structure.

For the sulfide solid electrolyte of the present invention having the Li ionic conductivity, for example, Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein, m and n represent a positive number; Z represents any one of Ge, Zn, and Ga), Li₂S—GeS₂, Li₂S—SiS₂—Li₃PO₄, Li₂S—SiS₂—LiₓMO_{y} (wherein, x and y represent a positive number. M represents any one of P, Si, Ge, B, Al, Ga, and In), and the like, can be used. Note here that the above description “Li₂S—P₂S₅” means a sulfide solid electrolyte formed by using raw material compositions including Li₂S and P₂S₅. The same is true to the other descriptions.

The sulfide solid electrolyte may be sulfide glass, crystallized sulfide glass, or a crystalline material obtained by a solid phase method. Note here that the sulfide glass can be obtained, for example, by performing mechanical milling (ball milling, and the like) on the raw material composition. The crystallized sulfide glass can be obtained, for example, by heat-treating the sulfide glass at a temperature equal to or higher than the crystallization temperature. The Li ion conductivity of the sulfide solid electrolyte at ordinary temperature is, for example, preferably 1×10⁻⁴ S/cm or more, and more preferably 1×10⁻³ S/cm or more.

(Surface Modifying Substance)

The electrode for a solid-state battery of the present invention includes a surface modifying substance. The surface modifying substance is a surface modifying agent with respect to at least one surface of the electrode active material and the solid electrolyte included in the electrode layer of the present invention. When at least one surface of the electrode active material and the solid electrolyte is surface-modified with the surface modifying substance having the following structural formula, decomposition of at least one of the electrode active material and the solid electrolyte by the binder or the solvent. In addition, it contributes to uniformity and stabilization of the electrode material mixture slurry.

[Type]

A surface modifying substance to be used for surface-modifying at least one of an electrode active material or a solid electrolyte included in the electrode for a solid-state battery of the present invention includes at least one selected from the group consisting of carboxylate, thiocarboxylate, carboxylic acid, thiocarboxylic acid, phosphate ester, thiophosphate ester, ketone, nitrile, alcohol, thiol, and ether. Specifically, for the surface modifying substance, at least one of the compounds shown by the following structural formula. Note here that in the following structural formula (1), R, R′, and R″ each represents a carbon chain, X represents an oxygen atom or a sulfur atom, and Li represents lithium. One surface modifying substance may be used alone or two types or more of surface modifying substances may be used in combination.

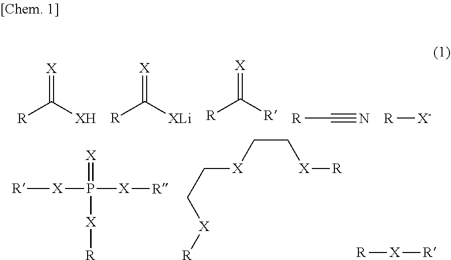

From the viewpoint that an alkyl chain is an insulator and does not conduct ions, R, R′, and R″ preferably include a carbon chain having 1 to 11 carbon atoms and more preferably include a carbon chain having 1 to 6 carbon atoms. Further preferably, R, R′, and R″ each includes a carbon chain having 1 to 4 carbon atoms. When R, R′, and R″ are aliphatic groups, they are not limited to linear chains, and may be branched or cyclic, saturated aliphatic groups or unsaturated aliphatic groups. A saturated aliphatic group is preferable. Furthermore, the carbon chain may contain a heteroatom between the carbon-carbon bonds. Furthermore, the carbon chain may have or may not have a substituent. When R, R′, and R″ are aromatic groups, they may be a phenyl group or a naphthyl group. Furthermore, the aromatic group may contain a heteroatom, between the carbon-carbon bonds. In addition, the aromatic group may have or may not have a substituent.

The surface modifying substances selected from each of the above structural formulae is preferably at least one selected from the group consisting of lithium butyrate, lithium isobutyrate, lithium acetate, phosphoric acid butyl ester, and isobutyronitrile.

When each functional group included in the surface modifying substances selected from the above structural formulae modifies a surface of at least one of the electrode active material or the solid electrolyte with the surface modifying substance, the surface of the electrode active material or the solid electrolyte is converted into a surface having a carbon chain. Thus, at least one of the electrode active material and the solid electrolyte has an affinity to a solvent, a binder, or the like, by the intermolecular interaction, so that decomposition does not easily occur. Furthermore, it is assumed that the electrode material mixture slurry and the solid electrolyte slurry are homogenized and stabilized because the affinity is improved by intermolecular interactions such as hydrophobic interactions, n-n stacking, hydrophilic interactions, electrostatic interactions (hydrogen bonds, van der Waals forces, etc.), and the like, which act between the electrode active material and solid electrolyte and the solvent and binder. Since these intermolecular interactions also act on the other components applicable to the solid-state battery, for example, a conductive auxiliary agent, even if the electrode material mixture or the solid electrolyte composition includes a conductive auxiliary agent, affinity is maintained, and the electrode material mixture slurry or the solid electrolyte slurry is homogenized and stabilized.

[Content]

The content of the surface modifying substance is 3% by mass or less with respect to the electrode material mixture after drying. The content is preferably 1% by mass or less, and more preferably 0.5% by mass or less. It is preferable that the content is 3% by mass or less because the content suppresses decomposition of at least one of the electrode active material or the solid electrolyte by the binder or the solvent, and contributes to homogenization and stabilization of the electrode material mixture slurry.

(Solvent)

A solvent to be used in the present invention is not particularly limited as long as it is a non-polar, low-polar, or medium-polar organic solvent having a boiling point in the range of 70° C. to 220° C., and may be appropriately selected according to the properties of a positive electrode active material, a solid electrolyte, or the like. In this case, the non-polar refers to a Snyder polarity parameter (or Rohrschneider polarity parameter) P′ value of −0.2≤P′<1.0, low polar refers to 1.0≤P′<2.5, and the medium polar refers to 1.0≤P′<5.5. Examples of solvents to be used preferably include aliphatic hydrocarbons, aromatic hydrocarbons, esters, ethers, ketones, nitriles, and the like. Since the solvent has an affinity based on the intermolecular interaction with the surface modifying substance and the binder, the slurry of the composition is homogenized and stabilized. Furthermore, it is also preferable to use, as a solvent, a surface modifying substance for modifying a surface of at least one of the electrode active material and the solid electrolyte. In this case, the surface modifying substance acts as a solvent for dispersing or dissolving the electrode active material or the solid electrolyte and the binder, or as a surface modifying substance for modifying a surface of at least one of the electrode active material and the solid electrolyte.

(Binder)

The electrode for a solid-state battery of the present invention includes a binder. The binder serves as a binding agent or a thickener in an electrode layer. Furthermore, the binder homogenizes electrode material mixture slurry and provides appropriate viscosity.

[Types]

Types of binders to be used for the electrode for a solid-state battery of the present invention are not particularly limited, and any binders may be used as long as they can be used as a binder for binding among the electrode active material, the solid electrolyte, and the other components, included in the electrode material mixture, or binding between the components included in the electrode material mixture and the current collector, in formation of an electrode layer. Examples thereof include acrylic acid-based polymers, cellulose-based polymers, styrene-based polymers, vinyl acetate-based polymers, urethane-based polymers, fluoroethylene-based polymers, methacrylate ester-based polymers, acrylate ester-base polymers, and the like. Styrene-based polymers, methacrylate ester polymers, acrylate ester polymers are preferable from the viewpoint that they are uniformly dispersed in an electrode material mixture and provide moderate viscosity.

Specific examples of the binder include polyvinylidene fluoride (PVdF), polymethyl methacrylate (PMMA), polyisobutene (PIB), styrene-butadiene rubber (SBR), polyethylene-vinyl acetate copolymer (PEVA), nitrile rubber (NBR), hydrogenated nitrile rubber (HNBR), and the like. These may be used alone or in combination of two or more of them. Structural formulae of binders to be preferably used in the present invention are shown the following Formulae (2). In the following Formulae (2), n and m represent arbitrary natural numbers.

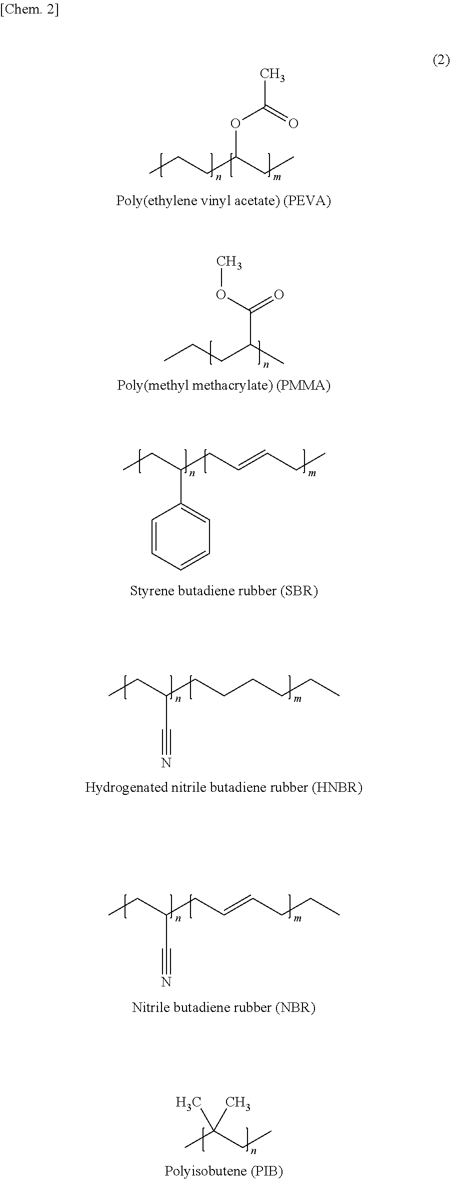

[Content]

The content of the binder is preferably 5% by mass or less, and more preferably 1.0% by mass or less with respect to the entire electrode material mixture after drying. When the content is 5% by mass or less, binding of the electrode active material, the solid electrolyte, the conductive auxiliary agent, the binder, and the current collector becomes sufficiently strong. Furthermore, it is preferable that the electrode material mixture slurry has appropriate viscosity and is provided with stability and uniformity.

(Conductive Auxiliary Agent)

The electrode for a solid-state battery of the present invention includes a conductive auxiliary agent. As the conductive auxiliary agent, conventionally known conductive auxiliary agents can be used. Specific examples of the conductive auxiliary agent include acetylene black, natural graphite, artificial graphite, and the like.

[Content]

The content of the conductive auxiliary agent is preferably 5% by mass or less, and more preferably 1% by mass or less with respect to the entire electrode material mixture after drying. When the content is 5% by mass or less, binding of the electrode active material, the solid electrolyte, the conductive auxiliary agent, the binder, and the current collector becomes sufficiently strong. This is preferable because the electrode material mixture slurry has appropriate viscosity and also provides stability and uniformity.

(Electrode Current Collector)

The positive electrode current collector 14 is not particularly limited as long as it has a function of carrying out current collection of the positive electrode layer, and examples thereof include aluminum, an aluminum alloy, stainless steel, nickel, iron, and titanium. Among them, aluminum, an aluminum alloy, and stainless steel are preferable. Furthermore, examples of the shape of the positive electrode current collector 14 include a foil shape, a plate shape and the like, and a porous shape and the like.

The negative electrode current collector 15 is not particularly limited as long as it has a function of carrying out current collection of the positive electrode layer 12. Examples of the material of the negative electrode current collector 15 include nickel, copper, stainless steel, and the like. Furthermore, examples of the shape of the negative electrode collector 15 include a foil shape, a plate shape and the like, and a porous shape and the like. Note here that in the present invention, a positive electrode current collector and a negative electrode current collector are collectively called an electrode current collector.

(Solid Electrolyte Layer)

A solid electrolyte layer is a layer laminated between a positive electrode layer and a negative electrode layer of a solid-state battery, and containing at least a solid electrolyte material. The charge transfer medium conduction between the positive electrode active material and the negative electrode active material can be performed through the solid electrolyte material included in the solid electrolyte layer. For the solid electrolyte material that can be used in the solid electrolyte layer, the above-mentioned solid electrolyte materials can be preferably used.

(Manufacturing Method)

### [Method for Manufacturing Electrode Layer]

Positive and negative electrode layers can be manufactured by placing slurry including an electrode material mixture on the surface of a current collector and drying the slurry. The method for manufacturing an electrode layer can use the same method as conventional method except that a surface of at least one of the electrode active material and the solid electrolyte is chemically modified with a surface modifying substance, and an electrode layer can be manufactured by a wet method or a dry method. Hereinafter, the case of manufacturing the electrode layer by the wet method will be described.

The electrode layer is manufactured by a step of dispersing at least one of an electrode active material and a solid electrolyte in a solvent in which a surface modifying substance is dissolved, and surface modifying at least one of the surface of the electrode active material and the solid electrolyte; a step of mixing slurry of an electrode material mixture surface-modified with the surface modifying substance obtained in the above step, a binder, and a conductive auxiliary agent to obtain a slurry solution of the electrode material mixture; and a step of applying a slurry solution of the electrode material mixture, and drying the mixture on the surface of an electrode current collector so as to form an electrode layer on the surface of the electrode current collector. For example, at least one of an electrode active material and a solid electrolyte and a surface modifying substance are mixed and dispersed in a solvent to obtain a slurry solution of an electrode material mixture in which surface modifying substance is surface-modified on at least one of the electrode active material and the solid electrolyte. At this time, a surface modifying substance may be used as a solvent. Next, materials constituting the electrode layer, such as a binder and a conductive auxiliary are mixed and dispersed in a slurry solution of the electrode material mixture to obtain a slurry solution of the electrode material mixture. At this time, when only one of the electrode active material and the solid electrolyte is surface-modified in the previous step, the remaining one is mixed in the electrode material mixture slurry. For mixing and dispersing the electrode active material, the solid electrolyte, the surface modifying substance, the binder, the conductive auxiliary agent, and the solvent, various mixers and dispersers such as an ultrasonic disperser, a shaker, and a FILMIX (trademark) can be used. The solid content of the electrode material mixture in the slurry solution is not particularly limited.

The electrode material mixture slurry solution thus obtained is applied on the surface of the electrode current collector and dried, and an electrode layer is formed on the surface of the electrode current collector. Thus, the electrode can be obtained. Herein, the solvent used to obtain the electrode material mixture slurry in the drying step is volatilized by drying, or at least one of the electrode active material and the solid electrolyte is surface-modified when the solvent is a surface modifying substance as a surface modifying agent, so that the solvent does not substantially remain in the obtained electrode layer. As another applying method, for example, a slurry solution mainly including an electrode active material and a slurry solution including a solid electrolyte can be individually prepared, and the components in each solution can be laminated while patterning at the time of laminating the electrode layers.

A method for applying slurry on the surface of the electrode current collector is not particularly limited, and an ink jet method, a screen printing method, a CVD method, a sputtering method, or the like, can be used, and in addition, a well-known coating methods such as a doctor blade method may be used. A total thickness (a thickness of the electrode) of the electrode layer and the electrode current collector after drying is not particularly limited, but, for example, is preferably 0.1 μm or more and 1 mm or less, and more preferably 1 μm or more and 200 μm or less, from the viewpoint of energy density and laminating property. Furthermore, the electrode may be produced through an optional pressing process. The pressure at the time of pressing the electrode can be about 100 MPa.

[Method for Manufacturing Solid Electrolyte Layer]

A solid electrolyte layer can be produced through, for example, a step of pressing a solid electrolyte. Alternatively, the solid electrolyte layer can also be produced through a process of coating the surface of a substrate or an electrode with a slurry solution of a solid electrolyte prepared by dispersing a solid electrolyte material or the like in a solvent. In manufacturing of the solid electrolyte layer, the surface of the solid electrolyte may be chemically modified in a solvent in which a surface modifying substance is dispersed. In this case, the surface of the solid electrolyte can be chemically modified by the same procedure as the electrode layer. Furthermore, common methods in this technical field can be appropriately applied for the method of manufacturing the solid electrolyte layer. For mixing and dispersing the solid electrolyte and the solvent, various mixers and dispersers such as an ultrasonic disperser, a shaker, and FILMIX (trade mark) can be used. The solid amount of the solid electrolyte in the slurry solution is not particularly limited.

Furthermore, in the case of manufacturing the solid electrolyte layer by the wet method, the method for applying the slurry solution of the solid electrolyte is not particularly limited, and an ink jet method, a screen printing method, a CVD method, a sputtering method, or the like, can be used, and in addition, other well-known applying methods such as a doctor blade may be used. In the solid electrolyte layer obtained by the drying process, the solvent used to obtain the solid electrolyte slurry is volatilized by drying, or modified on the surface of the solid electrolyte when the solvent is a surface modifying substance, so that the solvent does not substantially remain in the obtained solid electrolyte layer. A thickness of the solid electrolyte layer is largely different dependent on the configuration of the battery, but the thickness is, for example, preferably 0.1 μm or more and 1 mm or less, and more preferably 1 μm or more and 100 μm or less. Note here that when a surface of at least one of the electrode active material and the solid electrolyte in the electrode layer is chemically modified, the solid electrolyte in the solid electrolyte layer is not necessarily required to be surface-modified.

[Method for Manufacturing Solid-State Battery]

A solid-state battery including an electrode for a solid-state battery of the present invention will be described. The solid-state battery of the present invention is manufactured by laminating the above-mentioned positive electrode current collector, positive electrode layer, solid electrolyte layer, negative electrode layer, and negative electrode current collector sequentially in the order shown in FIG. 1. Note here that after these are laminated, these may be arbitrarily pressed and integrated. In manufacturing of the solid-state battery, usually used methods can be appropriately applied.

### Advantageous Effect

In the above, an electrode for a solid-state battery and a solid-state battery including the same of the present invention are described. The electrode for a solid-state battery and solid-state battery including the same of the present invention have the following advantageous effects.

The present invention has a configuration of an electrode for a solid-state battery including solid electrolyte including sulfide and/or oxide, an electrode active material, a binder, and a conductive auxiliary agent, at least one of the solid electrolyte and the electrode active material having a surface being modified with a surface modifying substance, wherein the surface modifying substance is at least one selected from the group consisting of carboxylate, thiocarboxylate, carboxylic acid, thiocarboxylic acid, phosphate ester, thiophosphate ester, ketone, nitrile, alcohol, thiol, and ether. Thus, at least one of the electrode active material and the solid electrolyte has an affinity to a solvent, a binder, or the like, by the intermolecular interaction, so that decomposition does not easily occur. Furthermore, the inside of the electrode layer is homogenized and stabilized. Therefore, in the electrode for a solid-state battery and the solid-state battery having the above-mentioned configuration, the electrode resistance is reduced, and the battery performance and the durability are improved.

### EXAMPLES

Hereinafter, the electrode of the present invention will be described in detail with reference to Examples.

### Example 1

### [Production of Solid Electrolyte]

Modification with butyric acid (A-1): In a glove box filled with argon gas, 0.02 grams (0.2% by mass) of butyric acid was dissolved in 20 grams of butyl butyrate (water concentration <20 ppm). To this solution, 10 grams of Li—P—S—Cl system solid electrolyte was mixed. After mixing for 12 hours, the butyl butyrate solvent was removed under reduced pressure to obtain a solid electrolyte having a surface that had been modified with butyric acid in accordance with Example 1.

FIG. 2 is a chart showing an IR spectrum of the solid electrolyte of Example 1. As shown in FIG. 2, in the IR spectrum, peaks of carboxylic acid and carboxylate were detected, demonstrating that the surface of the solid electrolyte was modified with carboxylic acid and carboxylate.

[Production of Positive Electrode]

As a positive electrode active material, 7.0 grams of lithium cobaltate having a surface coated with LiNbO₃ was used, and 3.0 grams of a solid electrolyte, 0.1 grams of acetylene black, and 1 gram of a 10 mass % xylene solution of polymethyl methacrylate were mixed with xylene to prepare slurry. The slurry was applied to the collector foil using an automatic bar coater to obtain a positive electrode layer.

[Production of Negative Electrode]

As a negative electrode active material, 7.0 grams of graphite was used, and 3.0 grams of solid electrolyte and 1 gram of a 10% by mass xylene solution of polymethyl methacrylate were mixed with xylene to prepare slurry. The slurry was applied to the collector foil using an automatic bar coater to obtain a negative electrode layer.

[Production of Positive Electrode Half-Cell]

The battery was produced by forming a compact powder on a ceramic tube having an inner diameter of 10 mm using 0.1 grams of the solid electrolyte prepared above, punching the positive electrode layer prepared above into a circle having a diameter of 10 mm, disposing the positive electrode layer and an indium-lithium alloy counter electrode so as to sandwich the compact, and press molding. In this case, the indium-lithium alloy counter electrode acts as a negative electrode.

[Production of Negative Electrode Half-Cell]

The battery was produced by forming a compact powder in a ceramic tube having an inner diameter of 10 mm using 0.1 grams of the solid electrolyte prepared above, punching the negative electrode layer prepared above into a circle having a diameter of 10 mm, disposing the negative electrode layer and an indium-lithium alloy counter electrode so as to sandwich the compact, and press molding thereof. In this case, the indium-lithium alloy counter electrode acts as a positive electrode.

### Example 2

A positive electrode half-cell and a negative electrode half-cell according to Example 2 were produced in the same manner as in Example 1 except that 0.02 grams of lithium butyrate was used instead of 0.02 grams of butyric acid in formation of a solid electrolyte.

### Example 3

A positive electrode half-cell and a negative electrode half-cell according to Example 3 were prepared in the same manner as in Example 1 except that 0.02 g of isobutyric acid was used instead of 0.02 g of butyric acid and hexane was used as a solvent in formation of a solid electrolyte.

### Example 4

A positive electrode half-cell and a negative electrode half-cell according to Example 4 were prepared in the same manner as in Example 1 except that 0.02 g of lithium isobutyrate was used instead of 0.02 g of butyric acid and isobutyl isobutyrate was used as a solvent in formation of a solid electrolyte.

### Example 5

A positive electrode half-cell and a negative electrode half-cell according to Example 5 were produced in the same manner as in Example 1 except that 0.02 grams of acetic acid was used instead of 0.02 grams of butyric acid in formation of the solid electrolyte.

### Example 6

A positive electrode half-cell and a negative electrode half-cell according to Example 6 were produced in the same manner as in Example 1 except that 0.02 grams of lithium acetate was used instead of 0.02 grams of butyric acid in formation of the solid electrolyte.

### Example 7

A positive electrode half-cell and a negative electrode half-cell according to Example 7 were produced in the same manner as in Example 1 except that 0.01 grams of butyric acid and 0.01 grams of lithium butyrate were used instead of 0.02 grams of butyric acid in formation of the solid electrolyte.

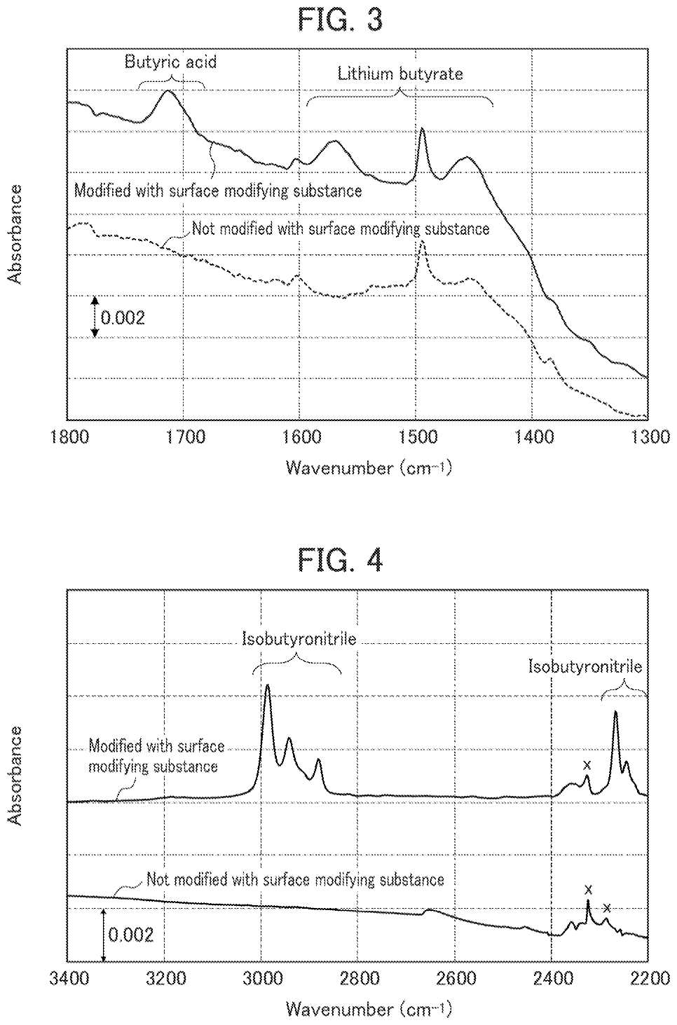

FIG. 3 is a chart showing an IR spectrum of a solid electrolyte of Example 7. As shown in FIG. 3, as compared with the IR spectrum of only solid electrolyte, in the IR spectrum of the solid electrolyte according to Example 7, peaks of butyric acid and lithium butyrate were detected, demonstrating that a surface of the solid electrolyte was modified with butyric acid and lithium butyrate.

### Example 8

A positive electrode half-cell and a negative electrode half-cell according to Example 8 were produced in the same manner as in Example 1 except that 0.02 grams of isobutyronitrile was used instead of 0.02 grams of butyric acid in formation of the solid electrolyte.

FIG. 4 is a chart showing an IR spectrum of a solid electrolyte of Example 8. As shown in FIG. 4, as compared with the IR spectrum of only solid electrolyte, in the IR spectrum of the solid electrolyte according to Example 8, a peak of isobutyronitrile was detected, demonstrating that a surface of the solid electrolyte was modified with isobutyronitrile.

### Example 9

A positive electrode half-cell and a negative electrode half-cell according to Example 9 were prepared in the same manner as in Example 1 except that 0.05 g of tributyl phosphate was used instead of 0.02 g of butyric acid and hexane was used as a solvent in formation of the solid electrolyte.

### Example 10

A positive electrode half-cell and a negative electrode half-cell according to Example 10 were prepared in the same manner as in Example 1 except that 0.02 g of anisole was used instead of 0.02 g of butyric acid and hexane was used as a solvent in formation of the solid electrolyte.

### Example 11

A positive electrode half-cell and a negative electrode half-cell according to Example 11 were prepared in the same manner as in Example 1 except that 0.02 g of dibutyl ether was used instead of 0.02 g of butyric acid and hexane was used as a solvent in formation of the solid electrolyte.

### Comparative Example 1

A positive electrode half-cell and a negative electrode half-cell according to Comparative Example 1 were prepared in the same manner as in Example 1 except that 0.02 grams of butyric acid was not added in formation of the solid electrolyte.

### <<Battery Performance Evaluation Test>>

Positive electrode half-cells and negative electrode half-cells according to Examples 1 to 11 and Comparative Example 1 were subjected to battery performance evaluation test in the following conditions. Charge and discharge cycles were carried out at 25° C. and at the charge and discharge rate of 0.1 c, and the discharge capacity (mAh) of the fifth cycle was defined as the positive electrode capacity and the negative electrode capacity, respectively. The capacity per weight of electrode active material with respect to each of the positive electrode capacity and the negative electrode capacity was calculated. The results are shown in Table 1.

TABLE 1

| | | | Positive electrode | Negative electrode |
|---|---|---|---|---|
| | | | capacity/Weight of | capacity/Weight of |
| | Surface modifying substance | | electrode active | electrode active |
| | | Content | material | material |
| | Type | (% by mass) | (mAh/g) | (mAh/g) |
| Example 1 | Butyric acid | 0.2 | 150 | 321 |
| Example 2 | Lithium butyrate | 0.2 | 151 | 320 |
| Example 3 | Isobutyric acid | 0.2 | 149 | 320 |
| Example 4 | Lithium | 0.2 | 148 | 318 |
| | Isobutyrate | | | |
| Example 5 | Acetic acid | 0.2 | 145 | 305 |
| Example 6 | Lithium acetate | 0.2 | 147 | 310 |
| Example 7 | Butyric | 0.1/0.1 | 150 | 322 |
| | acid/Lithium | | | |
| | butyrate | | | |
| Example 8 | Isobutyronitrile | 0.2 | 148 | 310 |
| Example 9 | Tributyl phosphate | 0.5 | 145 | 300 |
| Example 10 | Anisole | 0.2 | 150 | 315 |
| Example 11 | Dibutyl ether | 0.2 | 146 | 305 |
| Comparative | — | — | 130 | 280 |
| Example 1 | | | | |

As shown in Table 1, it is confirmed that the positive electrode half-cells and the negative electrode half-cells according to Examples had higher electrode capacity as compared with the positive electrode half-cell and negative electrode half-cell according to Comparative Example.

### EXPLANATION OF REFERENCE NUMERALS

10 Solid-state battery
11 Positive electrode layer
12 Negative electrode layer
13 Solid electrolyte layer
14 Positive electrode current collector
15 Negative electrode current collector

What is claimed is:

1. An electrode for a solid-state battery comprising a solid electrolyte including at least one of sulfide and oxide, an electrode active material, a binder, and a conductive auxiliary agent,
at least one of the solid electrolyte and the electrode active material having a surface being modified with a surface modifying substance,
wherein the surface modifying substance is at least one selected from the group consisting of carboxylate, thiocarboxylate, carboxylic acid, thiocarboxylic acid, phosphate ester, thiophosphate ester, ketone, nitrile, alcohol, thiol, and ether.

2. The electrode for a solid-state battery according to claim 1, wherein the surface modifying substance has a carbon chain having 1 to 11 carbon atoms.

3. The electrode for a solid-state battery according to claim 1, wherein the surface modifying substance has a carbon chain having 1 to 6 carbon atoms.

4. The electrode for a solid-state battery according to claim 1, wherein the surface modifying substance has a carbon chain having 1 to 4 carbon atoms.

5. The electrode for a solid-state battery according to claim 1, wherein the surface modifying substance is at least one selected from the group consisting of lithium butyrate, lithium isobutyrate, lithium acetate, butyl phosphate, and isobutyronitrile.

6. The electrode for a solid-state battery according to claim 1, wherein the binder is a binder having relatively lower polarity than the solid electrolyte and the electrode active material before a surface thereof is modified with the surface modifying substance, or a binder having no polarity.

7. The electrode for a solid-state battery according to claim 1, wherein the binder is at least one selected from the group consisting of polyethylene vinyl acetate (PEVA), polymethyl methacrylate (PMMA), styrene-butadiene rubber (SBR), hydrogenated nitrile-butadiene rubber (HNBR), nitrile-butadiene rubber (NBR) and polyisobutene (PIB).

8. The electrode for a solid-state battery according to claim 1, wherein the solid electrolyte is a sulfide solid electrolyte having an argyrodite type crystal structure.

9. The electrode for a solid-state battery according to claim 1, wherein the electrode active material is a positive electrode active material, and the electrode for a solid-state battery is a positive electrode for a solid-state battery.

10. A solid-state battery comprising the electrode for a solid-state battery according to claim 1.
